(19) United States
(12) Patent Application Publication
(10) Pub. No.: US 2024/0128006 A1
(43) Pub. Date: Apr. 18, 2024

(54) LAMINATED COIL COMPONENT

(71) Applicant: TDK CORPORATION, Tokyo (JP)

(72) Inventors: Yuya OSHIMA, Tokyo (JP); Hiroshi ONO, Tokyo (JP); Ryosuke HORIE, Tokyo (JP); Daiki YAMADA, Tokyo (JP); Yuki AKASAKA, Tokyo (JP); Shuichi WATANABE, Tokyo (JP); Satoshi TAKASU, Tokyo (JP); Makoto YOSHINO, Tokyo (JP); Takahiro YATA, Tokyo (JP)

(73) Assignee: TDK CORPORATION, Tokyo (JP)

(21) Appl. No.: 18/484,833

(22) Filed: Oct. 11, 2023

(30) Foreign Application Priority Data
Oct. 14, 2022 (JP) 2022-165578

(51) Int. Cl. H01F 17/00

(52) U.S. Cl. CPC H01F 17/0013

(57) ABSTRACT

A laminated coil component includes: an element body having a first surface and a second surface facing each other in a first direction; a coil unit formed by laminating a plurality of coil conductors in a second direction orthogonal to the first direction inside the element body; a first lead-out conductor; and a second lead-out conductor. A first coil conductor adjacent to the first lead-out conductor in the second direction includes a first side portion extending along the first surface, on a first surface side. A second coil conductor adjacent to the second lead-out conductor in the second direction includes a second side portion extending along the second surface, on a second surface side. The first side portion has a larger line width than other side portions of the first coil conductor and the second side portion.

### CROSS REFERENCE TO RELATED APPLICATIONS

This application claims priority to Japanese Patent Application No. 2022-165578 filed on Oct. 14, 2022, the entire contents of which are incorporated by reference herein.

### TECHNICAL FIELD

The present invention relates to a laminated coil component.

### BACKGROUND

A laminated coil component including an element body and external electrodes formed on surfaces of the element body is known (for example, Japanese Unexamined Patent Publication No. 2014-082280). In Japanese Unexamined Patent Publication No. 2014-082280, the laminated coil component includes a coil unit formed inside the element body; a lead-out conductor connected to the coil unit and exposed on one surface of the element body; and a lead-out conductor exposed on the other surface of the element body. The line widths of four side portions of coil conductors of the coil unit are constant.

### SUMMARY

In the laminated coil component having the above-described configuration, when each of the lead-out conductors and the coil conductors are laminated, the coil conductors in the vicinity of one lead-out conductor may collapse due to the influence of the lead-out conductor (shift with respect to the coil conductors of other layers). Accordingly, the desired characteristics of the laminated coil component cannot be obtained, which is a problem.

An object of one aspect of the present invention is to provide a laminated coil component capable of suppressing the occurrence of defective products by suppressing the collapse of coil conductors during lamination.

According to one aspect of the present invention, there is provided a laminated coil component including: an element body having a first surface and a second surface facing each other in a first direction; a coil unit formed by laminating a plurality of coil conductors in a second direction orthogonal to the first direction inside the element body; a first lead-out conductor connected to the coil unit inside the element body and exposed on the first surface; and a second lead-out conductor connected to the coil unit inside the element body and exposed on the second surface. A first coil conductor adjacent to the first lead-out conductor in the second direction includes a first side portion extending along the first surface, on a first surface side. A second coil conductor adjacent to the second lead-out conductor in the second direction includes a second side portion extending along the second surface, on a second surface side. The first side portion has a larger line width than other side portions of the first coil conductor and the second side portion.

In the laminated coil component, the first coil conductor adjacent to the first lead-out conductor in the second direction includes the first side portion extending along the first surface, on the first surface side. The second coil conductor adjacent to the second lead-out conductor in the second direction includes the second side portion extending along the second surface, on the second surface side. The first side portion of the first coil conductor is a portion that is likely to be affected by the first lead-out conductor during lamination. The second side portion of the second coil conductor is a portion that is not likely to be affected by the second lead-out conductor during lamination. On the other hand, the first side portion has a larger line width than the other side portions of the first coil conductor and the second side portion. Accordingly, during lamination, since the first side portion has a large line width, the influence from the first lead-out conductor can be reduced. As described above, since the collapse of the coil conductors during lamination is suppressed, the occurrence of defective products can be suppressed.

A third coil conductor adjacent to the first coil conductor on a side opposite to the first lead-out conductor in the second direction may include a third side portion extending along the first surface on the first surface side, and the third side portion may have a larger line width than other side portions of the third coil conductor and the second side portion. In such a manner, since not only the first coil conductor adjacent to the first lead-out conductor but also the third side portion on the first surface side of the third coil conductor of the next layer, are increased in line width, the collapse of the coil conductors can be further suppressed.

The second coil conductor may include a fourth side portion extending along the first surface on the first surface side, and the first side portion may have a larger line width than the fourth side portion. In such a manner, regarding the second coil conductor spaced apart from the first lead-out conductor, the line width of the fourth side portion on the first surface side is not increased. In such a manner, the unnecessary increase of the fourth side portion that is less affected by the first lead-out conductor can be suppressed.

The first side portion may be widened to both an outer peripheral side and an inner peripheral side of the coil unit, and may be increased in the line width compared to the other side portions of the first coil conductor. Accordingly, the first side portion can reduce the influence of the first lead-out conductor on both the outer peripheral side and the inner peripheral side.

According to the present invention, it is possible to provide the laminated coil component capable of suppressing the occurrence of defective products by suppressing the collapse of coil conductors during lamination.

### BRIEF DESCRIPTION OF THE DRAWINGS

FIG. 1 is a perspective view of a laminated coil component in the present embodiment.

FIG. 2 is a schematic cross-sectional view of the laminated coil component shown in FIG. 1.

FIG. 3 is an unfolded view when the laminated coil component shown in FIG. 1 is disassembled and each layer is viewed in a lamination direction.

FIGS. 4A to 4C show normal conductor patterns and wide conductor patterns of coil conductors.

FIGS. 5A to 5C show normal conductor patterns and wide conductor patterns of coil conductors.

FIGS. 6A and 6B are schematic views of an embodiment and a comparative example.

FIGS. 7A and 7B are unfolded views showing a modification example.

FIGS. 8A to 8D are views showing lead-out conductors according to modification examples.

### DETAILED DESCRIPTION

Hereinafter, an embodiment of the present invention will be described in detail with reference to the accompanying drawings. In the description of the drawings, the same reference signs will be used for the same or equivalent elements, and duplicate descriptions will be omitted.

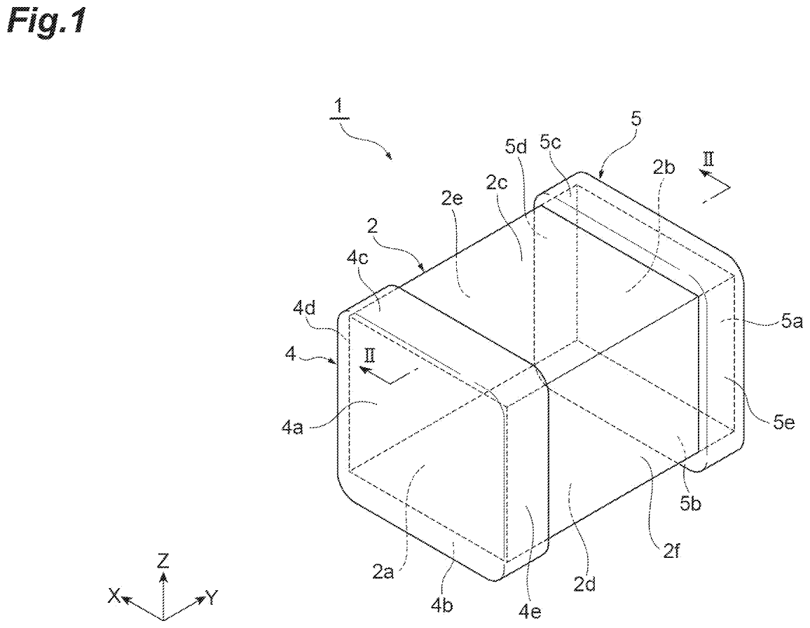

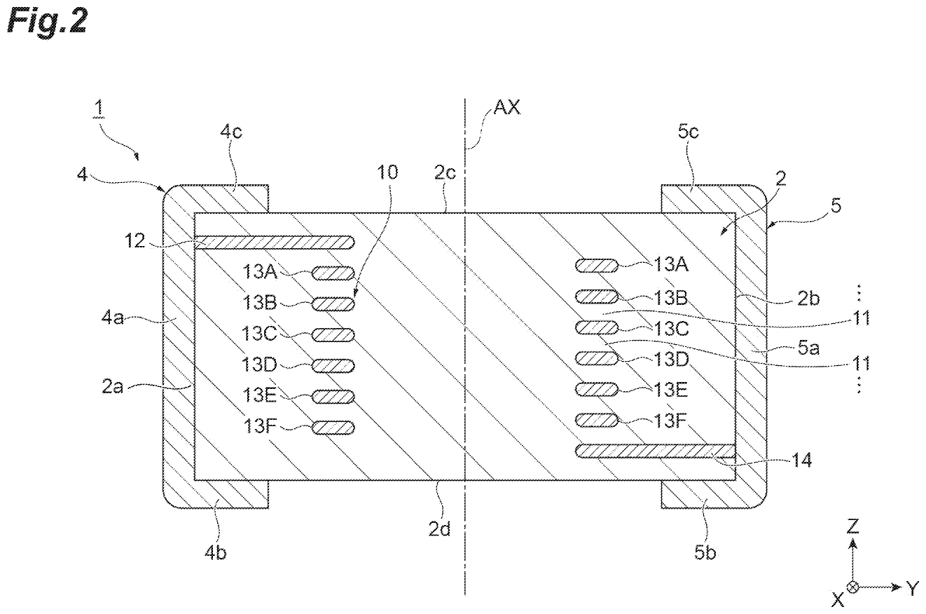

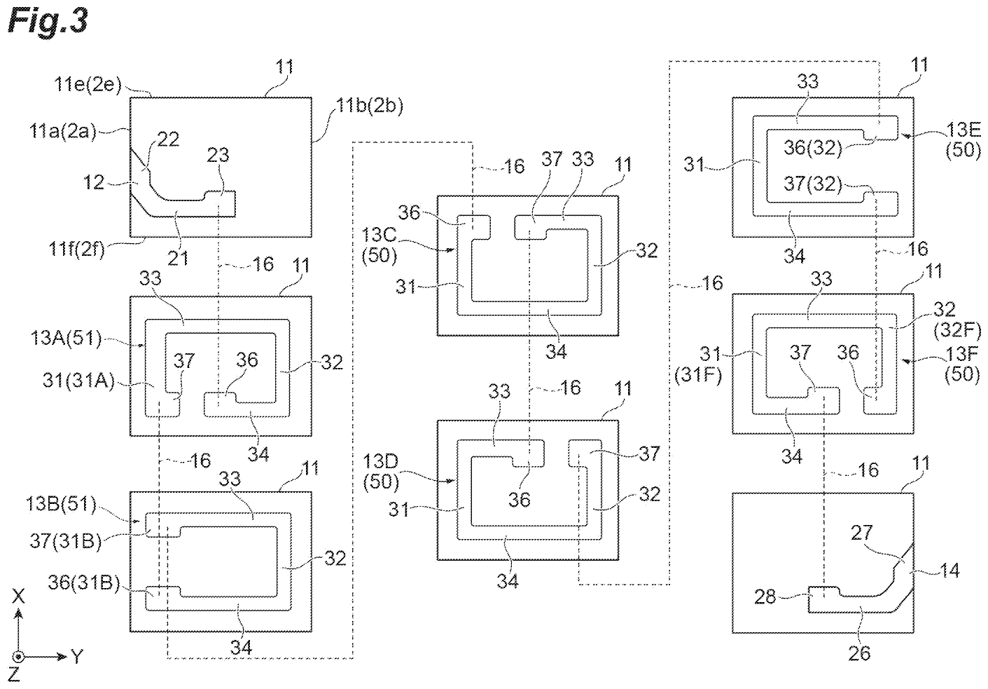

First, a schematic configuration of a laminated coil component 1 in the present embodiment will be described with reference to FIGS. 1 to 3. FIG. 1 is a perspective view of the laminated coil component 1 in the present embodiment. FIG. 2 is a schematic cross-sectional view of the laminated coil component of FIG. 1. FIG. 3 is an unfolded view when the laminated coil component 1 shown in FIG. 1 is disassembled and each layer is viewed in a lamination direction. An X-axis direction, a Y-axis direction, and a Z-axis direction are directions intersecting each other. The laminated coil component in the present embodiment is formed by laminating a plurality of layers in the Z-axis direction. The layers are integrated to such an extent that boundaries therebetween cannot be visually recognized. In the present embodiment, the X-axis direction, the Y-axis direction, and the Z-axis direction are orthogonal to each other. Although not particularly limited, in the present embodiment, the Y-axis direction corresponds to a “first direction” in the claims, and the Z-axis direction corresponds to a “second direction” in the claims.

An element body 2 has a rectangular parallelepiped shape. The element body 2 has, as outer surfaces, a pair of an end surface 2a (first surface) and an end surface 2b (second surface) facing each other in the Y-axis direction, and four side surfaces 2c, 2d, 2e, and 2f extending in a facing direction of the pair of end surfaces 2a and 2b so as to connect the pair of end surfaces 2a and 2b. The side surfaces 2c and 2d face each other in the Z-axis direction. The side surfaces 2e and 2f face each other in the X-axis direction. The side surface 2d is defined as, for example, a surface facing another electronic device (not shown) (for example, a circuit substrate or electronic component) when the laminated coil component 1 is mounted on the other electronic device.

The facing direction of the end surfaces 2a and 2b, a facing direction of the side surfaces 2c and 2d, and a facing direction of the side surfaces 2e and 2f are substantially orthogonal to each other. Incidentally, examples of the rectangular parallelepiped shape include a rectangular parallelepiped shape in which corners and edges are chamfered and a rectangular parallelepiped shape in which corners and edges are rounded.

As shown in FIG. 2, a coil unit 10, a lead-out conductor 12 (first lead-out conductor), and a lead-out conductor 14 (second lead-out conductor) are provided inside the element body 2. The coil unit 10 is formed by electrically connecting a plurality of coil conductors 13A, 13B, 13C, 13D, 13E, and 13F via through-holes. A central axis AX of the coil unit 10 extends in the Z-axis direction. The lead-out conductor 12 is connected to the coil unit 10 inside the element body 2, and is exposed on the end surface 2a. The lead-out conductor 14 is connected to the coil unit 10 inside the element body 2, and is exposed on the end surface 2b.

The element body 2 is formed by laminating a plurality of insulator layers 11, the plurality of coil conductors 13A, 13B, 13C, 13D, 13E, and 13F, and the lead-out conductors 12 and 14. The insulator layers 11 are laminated in the Z-axis direction. Hereinafter, the facing direction of the side surfaces 2c and 2d may be referred to as the “lamination direction”. Incidentally, a side surface 2c side in the lamination direction may be referred to as “top”, and a side surface 2d side in the lamination direction may be referred to as “bottom”, but are terms used to specify a positional relationship between the layers, and do not limit an up-down direction in a manufacturing state or usage state. Each of the insulator layers 11 has a substantially rectangular shape when viewed in the lamination direction (refer to FIG. 3).

The coil conductors 13A, 13B, 13C, 13D, 13E, and 13F and the lead-out conductors 12 and 14 are disposed spaced apart from each other in the lamination direction. The insulator layers 11 are disposed between the coil conductors 13A, 13B, 13C, 13D, 13E, and 13F and the lead-out conductors 12 and 14. The coil conductors 13A, 13B, 13C, 13D, 13E, and 13F and the lead-out conductors 12 and 14 have substantially the same thickness in the lamination direction. The coil conductors 13A, 13B, 13C, 13D, 13E, and 13F and the lead-out conductors 12 and 14 are disposed to overlap each other in the lamination direction with the insulator layers 11 sandwiched therebetween. In the present embodiment, the lead-out conductor 12, the coil conductors 13A, 13B, 13C, 13D, 13E, and 13F, and the lead-out conductor 14 are laminated in order from the top.

As the material of each of the insulator layers 11, an optimum material may be adopted according to the application of the laminated coil component 1. For example, when the laminated coil component 1 is a laminated ceramic coil, each of the insulator layers 11 is composed of a sintered body of glass ceramics containing Al, Zr, Ti, and the like. For example, when the laminated coil component 1 is a laminated ferrite coil, each of the insulator layers 11 may be a sintered body of ceramic green sheets containing ferrite materials such as Fe, Mn, and Zn. For example, when the laminated coil component 1 is a chip bead, each of the insulator layers 11 may be a sintered body of ceramic green sheets containing ferrite materials such as MnFe₂O₄ and ZnFe₂O₄.

As shown in FIG. 1, an external electrode 4 is disposed on an end surface 2a side of the element body 2, and an external electrode 5 is disposed on an end surface 2b side of the element body 2. Namely, the external electrodes 4 and 5 are located spaced apart from each other in the facing direction of the pair of end surfaces 2a and 2b. Each of the external electrodes 4 and 5 contains a conductive material (for example, Ag, Pd, or the like). Each of the external electrodes 4 and 5 is configured as a sintered body of conductive paste containing conductive metal powder (for example, Ag powder, Pd powder, or the like) and glass frits. A plating layer is formed on a surface of each of the external electrodes 4 and 5 by performing electroplating thereon. For example, Ni, Sn, or the like is used as the electroplating.

The external electrode 4 includes five electrode portions that are an electrode portion 4a located on the end surface 2a, an electrode portion 4b located on the side surface 2d, an electrode portion 4c located on the side surface 2c, an electrode portion 4d located on the side surface 2e, and an electrode portion 4e located on the side surface 2f. The electrode portion 4a covers the entirety of the end surface 2a. The electrode portion 4b covers a part of the side surface 2d. The electrode portion 4c covers a part of the side surface 2c. The electrode portion 4d covers a part of the side surface 2e. The electrode portion 4e covers a part of the side surface 2f. The five electrode portions 4a, 4b, 4c, 4d, and 4e are integrally formed.

The external electrode 5 includes five electrode portions that are an electrode portion 5a located on the end surface 2b, an electrode portion 5b located on the side surface 2d, an electrode portion 5c located on the side surface 2c, an electrode portion 5d located on the side surface 2e, and an electrode portion 5e located on the side surface 2f. The electrode portion 5a covers the entirety of the end surface 2b. The electrode portion 5b covers a part of the side surface 2d. The electrode portion 5c covers a part of the side surface 2c. The electrode portion 5d covers a part of the side surface 2e. The electrode portion 5e covers a part of the side surface 2f. The five electrode portions 5a, 5b, 5c, 5d, and 5e are integrally formed.

Next, a configuration of each of the coil conductors 13A, 13B, 13C, 13D, 13E, and 13F and the lead-out conductors 12 and 14 will be described in detail with reference to FIG. 3. As shown in FIG. 3, each of the insulator layers 11 includes edge portions 11a, 11b, 11e, and 11f. The edge portion 11a is formed at a position corresponding to the end surface 2a. The edge portion 11b is formed at a position corresponding to the end surface 2b. The edge portion 11e is formed at a position corresponding to the side surface 2e. The edge portion 11f is formed at a position corresponding to the side surface 2f. Incidentally, the reference signs for the edge portions 11a, 11b, 11e, and 11f are formed only on the insulator layer 11 of the lead-out conductor 12; however, the other insulator layers 11 include the same edge portions 11a, 11b, 11e, and 11f.

The lead-out conductor 12 includes a side portion 21, a lead-out side portion 22, and a pad portion 23. The side portion 21 extends along the edge portion 11f on an edge portion 11f (side surface 2f) side on a negative side of the X-axis direction. The side portion 21 is provided on an edge portion 11a (end surface 2a) side on a negative side of the Y-axis direction. The lead-out side portion 22 extends from an end portion of the side portion 21 on the negative side of the Y-axis direction to the edge portion 11a. The pad portion 23 forms a rectangular shape wider than a line width of the side portion 21, at an end portion of the side portion 21 on a positive side of the Y-axis direction.

The lead-out conductor 14 includes a side portion 26, a lead-out side portion 27, and a pad portion 28. The side portion 26 extends along the edge portion 11f on the edge portion 11f (side surface 2f) side on the negative side of the X-axis direction. The side portion 26 is provided on an edge portion 11b (end surface 2b) side on the positive side of the Y-axis direction. The lead-out side portion 27 extends from an end portion of the side portion 26 on the positive side of the Y-axis direction to the edge portion 11b. The pad portion 28 forms a rectangular shape wider than a line width of the side portion 26, at an end portion of the side portion 26 on the negative side of the Y-axis direction.

Each of the coil conductors 13A, 13B, 13C, 13D, 13E, and 13F includes side portions 31, 32, 33, and 34 and a pair of pad portions 36 and 37. The pad portion 36 forms a rectangular shape wider than a line width of each of the side portions, and is electrically connected to the pad portion of the conductor of the insulator layer 11 located one stage higher, via a through-hole conductor 16. The pad portion 37 forms a rectangular shape wider than the line width of each of the side portions, and is electrically connected to the pad portion of the conductor of the insulator layer 11 located one stage lower, via the through-hole conductor 16.

The side portion 31 extends along the edge portion 11a on the edge portion 11a (end surface 2a) side on the negative side of the Y-axis direction. The side portion 32 extends along the edge portion 11b on the edge portion 11b (end surface 2b) side on the positive side of the Y-axis direction. The side portion 33 extends along the edge portion 11e on an edge portion 11e (side surface 2e) side on the positive side of the X-axis direction. The side portion 34 extends along the edge portion 11f on the edge portion 11f (side surface 2f) side on the negative side of the X-axis direction. End portions of the side portions 31 and 32 on the positive side of the X-axis direction are connected to end portions of the side portion 33 in the Y-axis direction. End portions of the side portions 31 and 32 on the negative side of the X-axis direction are connected to end portions of the side portion 34 in the Y-axis direction. A conductor pattern having a substantially rectangular annular shape is formed by four side portions 31, 32, 33, and 34. In the conductor pattern, the conductor pattern is interrupted and the side portion is omitted in a region between the pad portion 36 and the pad portion 37.

The coil conductor 13A (first coil conductor) is adjacent to the lead-out conductor 12 on the upper side in the Z-axis direction. The coil conductor 13A includes the pad portion 36 at substantially the center position of the side portion 34 in the Y-axis direction, and includes the pad portion 37 at an end portion of the side portion 31 on the negative side of the X-axis direction.

The coil conductor 13B (third coil conductor) is adjacent to the coil conductor 13A on a side opposite to the lead-out conductor 12 in the Z-axis direction. The coil conductor 13B includes the pad portion 36 at an end portion of the side portion 34 on the negative side of the Y-axis direction, and includes the pad portion 37 at an end portion of the side portion 33 on the negative side of the Y-axis direction. Incidentally, the pad portion 36 includes a portion protruding from the side portion 34 to the positive side in the X-axis direction. The pad portion 37 includes a portion protruding from the side portion 33 to the negative side in the X-axis direction. Therefore, the protruding portions of the pad portions 36 and 37 function as the side portion 31.

The coil conductor 13C is adjacent to the coil conductor 13B on the upper side in the Z-axis direction. The coil conductor 13C includes the pad portion 36 at an end portion of the side portion 31 on the positive side of the X-axis direction, and includes the pad portion 37 at substantially the center position of the side portion 33 in the Y-axis direction. The coil conductor 13D is adjacent to the coil conductor 13C on the upper side in the Z-axis direction. The coil conductor 13D includes the pad portion 37 at an end portion of the side portion 32 on the positive side of the X-axis direction, and includes the pad portion 36 at substantially the center position of the side portion 33 in the Y-axis direction.

The coil conductor 13E is adjacent to the coil conductor 13F on a side opposite to the lead-out conductor 14 in the Z-axis direction. The coil conductor 13E includes the pad portion 37 at an end portion of the side portion 34 on the positive side of the Y-axis direction, and includes the pad portion 36 at an end portion of the side portion 33 on the positive side of the Y-axis direction. Incidentally, the pad portion 37 includes a portion protruding from the side portion 34 to the positive side in the X-axis direction. The pad portion 36 includes a portion protruding from the side portion 33 to the negative side in the X-axis direction. Therefore, the protruding portions of the pad portions 36 and 37 function as the side portion 32.

The coil conductor 13F (second coil conductor) is adjacent to the lead-out conductor 14 on the lower side in the Z-axis direction. The coil conductor 13F includes the pad portion 37 at substantially the center position of the side portion 34 in the X-axis direction, and includes the pad portion 36 at an end portion of the side portion 32 on the negative side of the Y-axis direction.

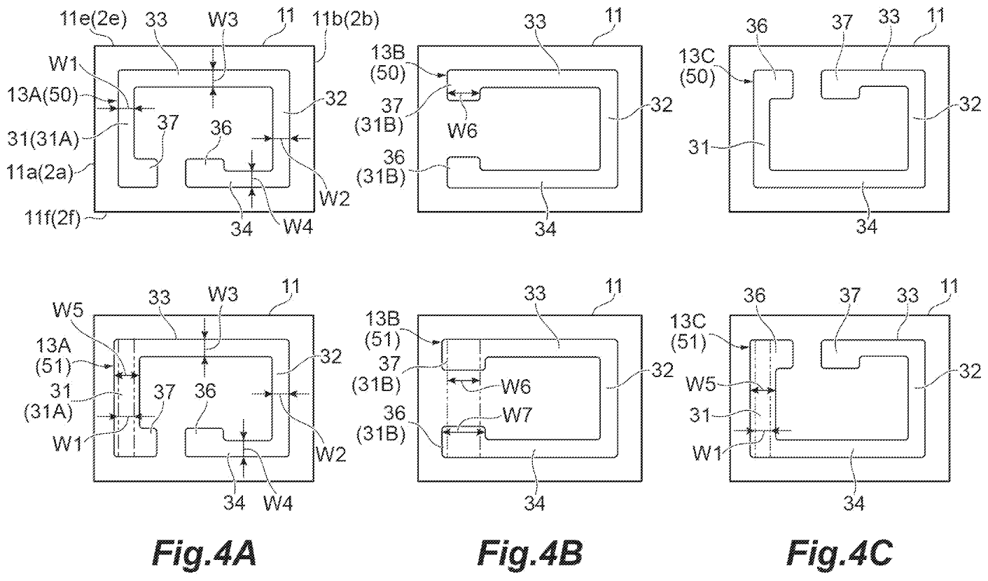

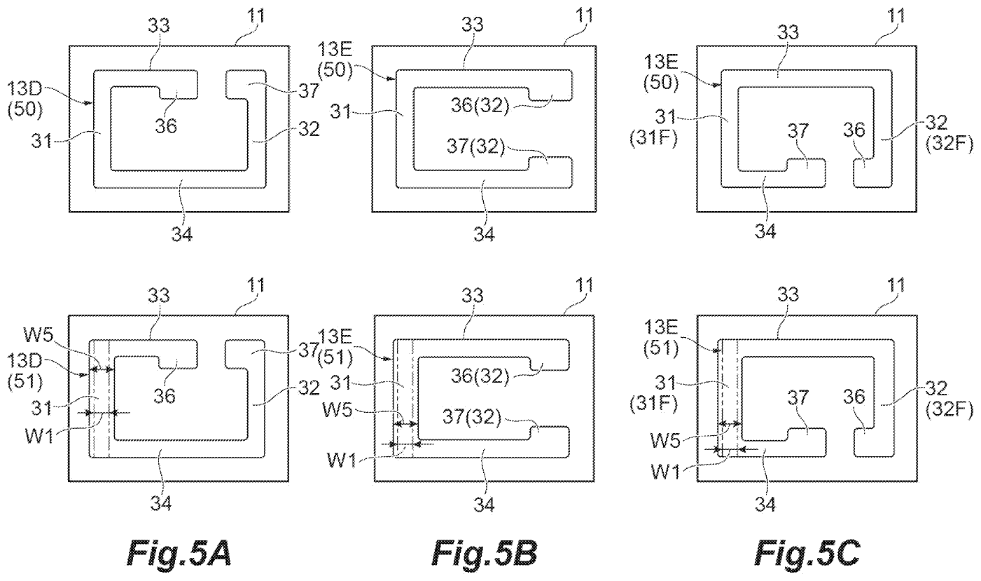

Here, in the present embodiment, a normal conductor pattern 50 in which the line width of the side portion 31 is the same as that of the other side portions and a wide conductor pattern 51 in which the line width of the side portion 31 is larger are used. In the wide conductor pattern 51, the side portion 31 along the edge portion 11a (end surface 2a) has a larger line width than the other side portions 32, 33, and 34. The normal conductor pattern 50 and the wide conductor pattern 51 will be described with reference to FIGS. 4A to 5C. FIGS. 4A, 4B, and 4C show the coil conductors 13A, 13B, and 13C, respectively. FIGS. 5A, 5B, and 5C show the coil conductors 13D, 13E, and 13F, respectively. The upper sides of FIGS. 4A, 4B, and 4C and FIGS. 5A, 5B, and 5C show the normal conductor pattern 50, and the lower sides show the wide conductor pattern 51.

As shown in FIG. 4A, the side portions 31, 32, 33, and 34 of the coil conductor 13A of the normal conductor pattern 50 have line widths W1, W2, W3, and W4, respectively. The line widths are dimensions in directions orthogonal to extending directions of the side portions 31, 32, 33, and 34 and to the lamination direction. The line widths W1, W2, W3, and W4 may be the same dimension, or may be dimensions different from each other within a range where the performance is not affected. On the other hand, the side portion 31 of the wide conductor pattern 51 has a line width W5 larger than the line width W1. The line width W5 is larger than the line widths W2, W3, and W4 of the other side portions 32, 33, and 34. On the side portion 31 of the wide conductor pattern 51 on the lower side, the line width of the side portion 31 in the normal conductor pattern 50 is indicated by an imaginary line. As indicated by the imaginary line, the side portion 31 in the wide conductor pattern 51 is widened to both an outer peripheral side and an inner peripheral side of the coil unit 10, and is increased in line width compared to the side portions 32, 33, and 34.

As shown in FIG. 4B, in the coil conductor 13B of the normal conductor pattern 50, the side portion 31 formed by the pad portions 36 and 37 has a line width W6 larger than the other line widths. The side portion 31 of the wide conductor pattern 51 has a line width W7 larger than the line width W6. On the side portion 31 of the wide conductor pattern 51 on the lower side, the line width of the side portion 31 in the normal conductor pattern 50 is indicated by an imaginary line. As indicated by the imaginary line, the side portion 31 in the wide conductor pattern 51 is widened to both the outer peripheral side and the inner peripheral side of the coil unit 10, and is increased in line width compared to the side portion 31 in the normal conductor pattern 50.

As shown in FIG. 4C and FIGS. 5A, 5B, and 5C, regarding the other coil conductors 13C, 13D, 13E, and 13F, the side portion 31 of the normal conductor pattern 50 has the line width W1, and the side portion 31 of the wide conductor pattern 51 has the line width W5.

As shown in FIG. 3, in the laminated coil component 1 according to the present embodiment, the wide conductor patterns 51 are used for the coil conductors 13A and 13B of the first and second layers from the top, and the normal conductor patterns 50 are used for the other coil conductors 13C, 13D, 13E, and 13F.

A side portion 31A (first side portion) of the coil conductor 13A (first coil conductor) has a larger line width than the other side portions 32, 33, and 34 of the coil conductor 13A and the side portion 32 (second side portion) of the coil conductor 13F (second coil conductor). In addition, a side portion 31B (third side portion) of the coil conductor 13B (third coil conductor) has a larger line width than the other side portions 32, 33, and 34 of the coil conductor 13B and the side portion 32 of the coil conductor 13F. The side portion 31A of the coil conductor 13A and the side portion 31B of the coil conductor 13B have larger line widths than a side portion 31F (fourth side portion) of the coil conductor 13F. In addition, the side portion 31A of the coil conductor 13A and the side portion 31B of the coil conductor 13B have larger line widths than the side portions 31 of the other coil conductors 13C, 13D, and 13E.

Next, actions and effects of the laminated coil component 1 according to the present embodiment will be described.

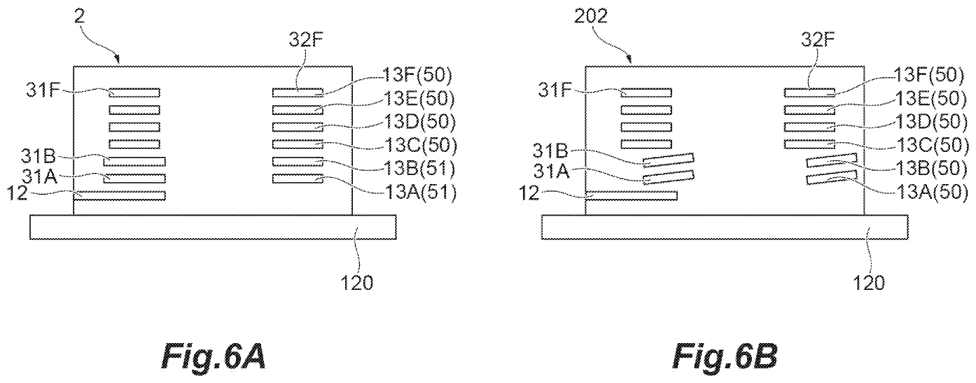

First, an element body 202 of a laminated coil component according to a comparative example will be described with reference to FIG. 6B. In the element body 202, the normal conductor patterns 50 are used for all the coil conductors 13A, 13B, 13C, 13D, 13E, and 13F including the coil conductors 13A and 13B. For this reason, the line widths of the side portions 31A and 31B close to the lead-out conductor 12 are the same as that of the side portion 31F. When the lamination of the element body 202 is performed, a lead-out conductor 12 side is pressed against a base member 120. For this reason, the coil conductors 13A and 13B in the vicinity of the lead-out conductor 12 may collapse (shift with respect to the coil conductors of the other layers) due to the influence of the lead-out conductor 12. Specifically, since the lead-out side portion 22 of the lead-out conductor 12 is located on the outer peripheral side of the coil conductor 13A, the coil conductor 13A is pushed out to the inner peripheral side of the coil during lamination, so that a collapse may occur. Accordingly, the desired characteristics of the laminated coil component cannot be obtained, which is a problem.

On the other hand, in the laminated coil component 1 according to the present embodiment, the coil conductor 13A adjacent to the lead-out conductor 12 in the Z-axis direction includes the side portion 31A extending along the end surface 2a, on the end surface 2a side. The coil conductor 13F adjacent to the lead-out conductor 14 in the Z-axis direction includes a side portion 32F extending along the end surface 2b, on the end surface 2b side. The side portion 31A of the coil conductor 13A is a portion that is likely to be affected by the lead-out conductor 12 during lamination. The side portion 32F of the coil conductor 13F is a portion that is not likely to be affected by the lead-out conductor 12 during lamination. On the other hand, the side portion 31A has a larger line width than the other side portions 32, 33, and 34 of the coil conductor 13A and the side portion 32F. Accordingly, during lamination, since the side portion 31A has a large line width, the influence from the lead-out conductor 12 can be reduced. As described above, since the collapse of the coil conductors during lamination is suppressed (for example, refer to FIG. 6A), the occurrence of defective products can be suppressed.

The coil conductor 13B adjacent to the coil conductor 13A on the side opposite to the lead-out conductor 12 in the Z-axis direction may include the side portion 31B extending along the end surface 2a on the end surface 2a side, and the side portion 31B may have a larger line width than the other side portions 32, 33, and 34 of the coil conductor 13B and the side portion 32F. In such a manner, since not only the coil conductor 13A adjacent to the lead-out conductor 12 but also the side portion 31B on the end surface 2a side of the coil conductor 13B of the next layer, are increased in line width, the collapse of the coil conductors can be further suppressed.

The coil conductor 13F may include the side portion 31F extending along the end surface 2b on the end surface 2b side, and the side portion 31A may have a larger line width than the side portion 31F. In such a manner, regarding the coil conductor 13F spaced apart from the lead-out conductor 12, the line width of the side portion 31F on the end surface 2b side is not increased. In such a manner, the unnecessary increase of the side portion 31F that is less affected by the lead-out conductor 12 can be suppressed.

The side portion 31A is widened to both the outer peripheral side and the inner peripheral side of the coil unit 10, and is increased in line width compared to the other side portions 32, 33, and 34 of the coil conductor 13A. Accordingly, the side portion 31A can reduce the influence of the lead-out conductor 12 on both the outer peripheral side and the inner peripheral side.

The present invention is not limited to the above-described embodiment.

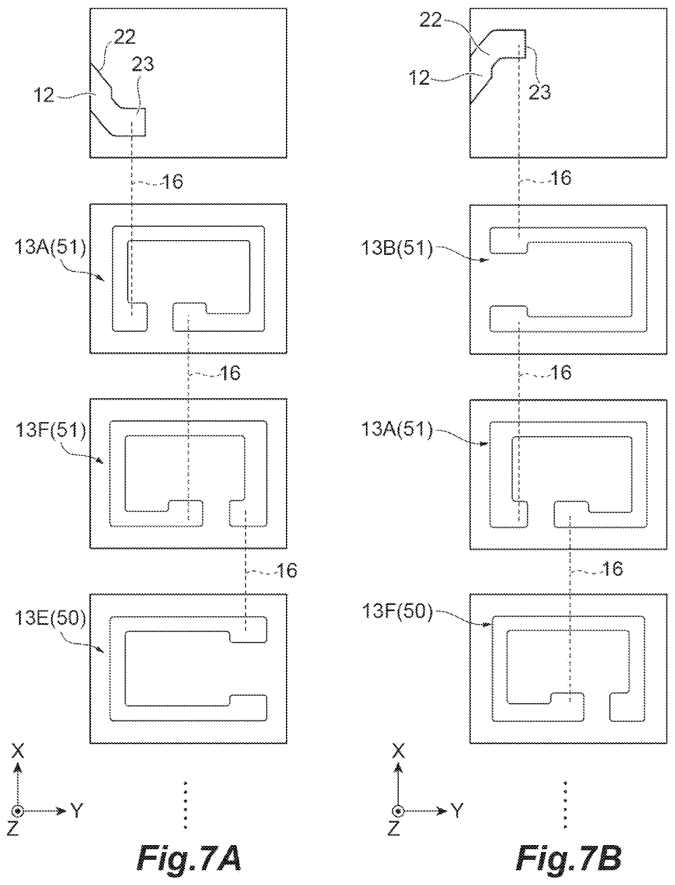

For example, the shapes of the lead-out conductors are not particularly limited, and can be changed as appropriate. In addition, the lamination order of the coil conductors and the like can also be changed as appropriate along with a change in the configurations of the lead-out conductors, and for example, the lead-out conductor 12 shown in FIG. 7A has a configuration in which the side portion 21 is omitted compared to the configuration of FIG. 3. In this case, the coil conductors 13A, 13F, and 13E may be laminated in order from the top. At this time, the wide conductor patterns 51 may be used as the coil conductors 13A and 13F of the first and second layers. The lead-out conductor 12 shown in FIG. 7B is disposed to extend to the positive side of the X-axis direction, unlike the lead-out conductor 12 as shown in FIG. 7A. In this case, the coil conductors 13B, 13A, and 13F may be laminated in order from the top. At this time, the wide conductor patterns 51 may be used as the coil conductors 13B and 13A of the first and second layers.

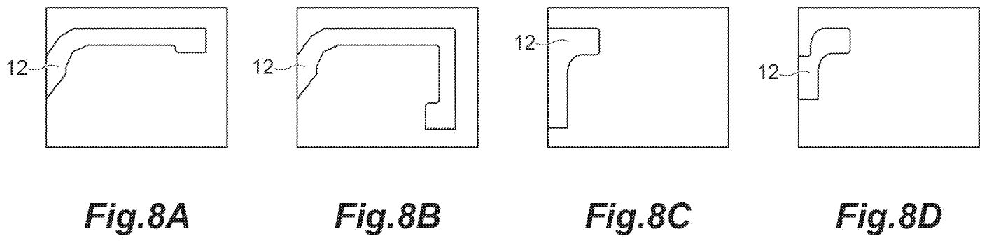

In addition, the shapes shown in FIGS. 8A, 8B, 8C, and 8D may be adopted as that of the lead-out conductor 12.

In addition, the shape of the coil conductor of each layer is not limited to the above-described embodiment, and can be changed as appropriate.

[Mode 1]

There is provided a laminated coil component including:
an element body having a first surface and a second surface facing each other in a first direction;
a coil unit formed by laminating a plurality of coil conductors in a second direction orthogonal to the first direction inside the element body;
a first lead-out conductor connected to the coil unit inside the element body and exposed on the first surface; and
a second lead-out conductor connected to the coil unit inside the element body and exposed on the second surface,
wherein a first coil conductor adjacent to the first lead-out conductor in the second direction includes a first side portion extending along the first surface, on a first surface side,
a second coil conductor adjacent to the second lead-out conductor in the second direction includes a second side portion extending along the second surface, on a second surface side, and
the first side portion has a larger line width than other side portions of the first coil conductor and the second side portion.

[Mode 2]

In the laminated coil component according to Mode 1,
wherein a third coil conductor adjacent to the first coil conductor on a side opposite to the first lead-out conductor in the second direction includes a third side portion extending along the first surface on the first surface side, and the third side portion has a larger line width than other side portions of the third coil conductor and the second side portion.

[Mode 3]

In the laminated coil component according to Mode 1 or 2,
wherein the second coil conductor includes a fourth side portion extending along the first surface on the first surface side, and
the first side portion has a larger line width than the fourth side portion.

[Mode 4]

In the laminated coil component according to any one of Modes 1 to 3,
wherein the first side portion is widened to both an outer peripheral side and an inner peripheral side of the coil unit, and is increased in the line width compared to the other side portions of the first coil conductor.

### REFERENCE SIGNS LIST

1: laminated coil component, 2: element body, 2a: end surface (first surface), 2b: end surface (second surface), 10: coil unit, 12: lead-out conductor (first lead-out conductor), 14: lead-out conductor (second lead-out conductor), 13A: coil conductor (first coil conductor), 13F: coil conductor (second coil conductor), 13B: coil conductor (third coil conductor), 31A: side portion (first side portion), 31B: side portion (third side portion), 31F: side portion (fourth side portion), 32F: side portion (second side portion).

What is claimed is:

1. A laminated coil component comprising:
an element body having a first surface and a second surface facing each other in a first direction;
a coil unit formed by laminating a plurality of coil conductors in a second direction orthogonal to the first direction inside the element body;
a first lead-out conductor connected to the coil unit inside the element body and exposed on the first surface; and
a second lead-out conductor connected to the coil unit inside the element body and exposed on the second surface,
wherein a first coil conductor adjacent to the first lead-out conductor in the second direction includes a first side portion extending along the first surface, on a first surface side,
a second coil conductor adjacent to the second lead-out conductor in the second direction includes a second side portion extending along the second surface, on a second surface side, and
the first side portion has a larger line width than other side portions of the first coil conductor and the second side portion.

2. The laminated coil component according to claim 1,
wherein a third coil conductor adjacent to the first coil conductor on a side opposite to the first lead-out conductor in the second direction includes a third side portion extending along the first surface on the first surface side, and the third side portion has a larger line width than other side portions of the third coil conductor and the second side portion.

3. The laminated coil component according to claim 1,
wherein the second coil conductor includes a fourth side portion extending along the first surface on the first surface side, and
the first side portion has a larger line width than the fourth side portion.

4. The laminated coil component according to claim 1,
wherein the first side portion is widened to both an outer peripheral side and an inner peripheral side of the coil unit, and is increased in the line width compared to the other side portions of the first coil conductor.
